(19) United States
(12) Patent Application Publication
(10) Pub. No.: US 2006/0010597 A1
(43) Pub. Date: Jan. 19, 2006

(54) Track supported ceiling lift turntable

(76) Inventor: Mike Wilson, Toronto (CA)

Correspondence Address: MIKE WILSON;c/o UNIT 33, 2280 MUNN'S AVENUE EAST, OAKVILLE, ON, L6H 3L1, CA

(21) Appl. No.: 11/181,322

(22) Filed: Jul. 14, 2005

Related U.S. Application Data
(60) Provisional application No. 60/521,868, filed on Jul. 14, 2004.

(51) Int. Cl. A61G 7/10

(52) U.S. Cl. 5/83.1

(57) ABSTRACT

A track supported ceiling lift turntable for use in a patient transfer track system comprises a perimeter frame member, and a rotatable turntable track member operatively mounted on the perimeter frame member for rotation about a substantially vertical central pivot axis, for supporting a carriage having a patient lift mechanism suspended therefrom, in movable relation the rotatable turntable track member. A plurality of access passageways are disposed around the circumference of the perimeter frame member, and permit access of a carriage to the rotatable turntable track member from ceiling tracks and from the rotatable turntable track member to ceiling tracks. A motor or rope is used to rotate the rotatable turntable track member about the vertical central pivot axis to alignment with a selected one of the plurality of access passageways, to thereby permit access by a carriage having a patient lift mechanism suspended therefrom.

### FIELD OF THE INVENTION

The present invention relates to track systems for use in a medical facility and the like for transferring patients, and more particularly to a such track systems having a junction and a plurality of tracks, wherein a patient can be transferred in any one of a number of directions on the tracks, and to turntables used in such track systems.

### BACKGROUND OF THE INVENTION

It is necessary in medical care facilities, such as hospitals, to transfer injured or other limited mobility patients between a bed, a wheelchair, a washroom, or other locations. Such transferring is often very difficult to do, and it may be injurious to the patient, if done manually by hand by one or more nurses or orderlies. Accordingly, various types apparatus and systems are employed that permit ready lifting, carrying, maneuvering, and so on, of injured or otherwise low mobility patients.

One type of apparatus used to hoist and transfer invalid patience is shown in U.S. Pat. No. 6,329,612, issued Dec. 11, 2001 to von Schroeder and entitled Invalid Hoists. This hoist comprises a wheeled base, a mast extending upwardly from the base, and a lifting arm that can be raised and lowered extending outwardly from the mast. This type of apparatus has many disadvantages associated with it. The main disadvantage is that it is very difficult to move on all but the hardest floors, especially when supporting a heavy patient. It also has a limited lift range and is not overly manoeuvrable. Further, type of apparatus typically takes up a lot of floor space.

More recently, it has become more common to install fixed tracks in the ceiling of a medical facility. These tracks are positioned to extend between each of the locations that a person wold need to be transferred to. For instance, in a hospital room, the tracks would extend from the side of a patient's bed to the doorway and to the washroom, thus enabling at nurse or orderly to transfer a patient from a wheelchair at the doorway of the room to the bed, and also vice versa, and also from the bed to the washroom and back again.

A significant problem arises when there are several beds in one hospital room. It is therefore necessary to have several tracks on the ceiling, one track from each bed to the entrance doorway, and one track from each bed to the bathroom, and so on.

Various types of track based patient movement systems are shown in U.S. Pat. No. 6,523,195 issued Feb. 25, 2003 to Brodeur et al., U.S. Pat. No. 6,568,003 issued May 27, 2003 to Vest, and U.S. Pat. No. 6,675,412 issued Jan. 13, 2004 to Faucher et al.

Such track-based systems, in essence, become the universal carrier for various types of lifting devices. The specific type of lifting device is chosen depending on a person's size, weight, and their particular medical situation (whether they are slightly injured, severely injured, disabled, elderly, and so on).

In order to access several places via a ceiling track system, it is known to use a turntable at a common junction point in a room. Such prior art turntables are typically quite heavy and are suspended from a load bearing point in the ceiling. Such installation is labour intensive, expensive, and can be difficult to do in many cases, depending on the type of ceiling.

It is an object of the present invention to provide a track supported ceiling lift turntable for use in a patient transfer track system.

It is another object of the present invention to provide a track supported ceiling lift turntable for use in a patient transfer track system, which track supported ceiling lift turntable is not overly heavy.

It is a further object of the present invention to provide a track supported ceiling lift turntable for use in a patient transfer track system, which track supported ceiling lift turntable is not suspended from a load bearing point in the ceiling.

It is a further object of the present invention to provide a track supported ceiling lift turntable for use in a patient transfer track system, which track supported ceiling lift turntable is not intensive to install.

It is a further object of the present invention to provide a track supported ceiling lift turntable for use in a patient transfer track system, which track supported ceiling lift turntable is inexpensive.

It is a further object of the present invention to provide a track supported ceiling lift turntable for use in a patient transfer track system, which track supported ceiling lift turntable is readily installed.

### SUMMARY OF THE INVENTION

In accordance with one aspect of the present invention there is disclosed a novel track supported ceiling lift turntable for use in a patient transfer track system having a carriage means having a patient lift mechanism suspended therefrom. The track supported ceiling lift turntable comprises a perimeter frame member, and a rotatable turntable track member operatively mounted on the perimeter frame member for rotation about a substantially vertical central pivot axis, for supporting a carriage means having a patient lift mechanism suspended therefrom, in movable relation the rotatable turntable track member. A plurality of access passageways are disposed around the circumference of the perimeter frame members. The plurality of access passageways are for permitting access of a carriage means to the rotatable turntable track member from ceiling tracks and from the rotatable turntable track member to ceiling tracks. There is means to rotate the rotatable turntable track member about the vertical central pivot axis to alignment with a selected one of the plurality of access passageways, to thereby permit access by a carriage means having a patient lift mechanism suspended therefrom.

In accordance with another aspect of the present invention there is disclosed a novel patient transfer track system comprising a plurality of ceiling tracks each secured to a ceiling in a building. A carriage means has a patient lift mechanism suspended therefrom and is movable along the plurality of ceiling tracks. A track supported ceiling lift turntable has a rotatable turntable track member and a plurality of access passageways disposed around the circumference thereof, and is for permitting the access of the carriage means to the rotatable turntable track member from the ceiling tracks and from the rotatable turntable track member to the ceiling tracks. There is means to rotate the rotatable turntable track member into alignment with a selected one of the plurality of access passageways, to thereby permit access by a carriage means having a patient lift mechanism suspended therefrom.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described herein below.

### BRIEF DESCRIPTION OF THE DRAWINGS

The novel features which are believed to be characteristic of the track supported ceiling lift turntable and patient transfer track system according to the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 is a bottom plan view of the preferred embodiment of the track supported ceiling lift turntable and patient transfer track system according to the present invention, installed in a ceiling;

FIG. 2 is a bottom plan view of the preferred embodiment track supported ceiling lift turntable of FIG. 1, with the rotatable turntable track member in a first rotated position;

FIG. 3 is a bottom plan view similar to FIG. 2, but with the rotatable turntable track member in a second rotated position;

FIG. 4 is a bottom plan view similar to FIG. 2, but with the rotatable turntable track member in a third rotated position;

FIG. 5 is a top plan view of the preferred embodiment track supported ceiling lift turntable of FIG. 1, also showing end portions of four ceiling tracks;

FIG. 6 is a first side elevational view of the preferred embodiment track supported ceiling lift turntable of FIG. 1;

FIG. 7 is a second side elevational view of the preferred embodiment track supported ceiling lift turntable of FIG. 1;

FIG. 8 is a sectional side elevational view of the preferred embodiment track supported ceiling lift turntable of FIG. 1, taken along section line 8-8 of FIG. 2;

FIG. 9 is a sectional side elevational view of the preferred embodiment track supported ceiling lift turntable of FIG. 1, taken along section line 9-9 of FIG. 2;

FIG. 10 is an enlarged bottom plan view of a portion of the track supported ceiling lift turntable of FIG. 1, specifically showing a stop screw;

FIG. 11 is an enlarged bottom plan view of a portion of the track supported ceiling lift turntable of FIG. 1, specifically showing the rope mount; and,

FIG. 12 is a side elevational view of the track supported ceiling lift turntable and patient transfer track system according to the present invention, also showing a carriage mechanism having a patient lift mechanism suspended therefrom.

### DETAILED DESCRIPTION OF A PREFERRED EMBODIMENT

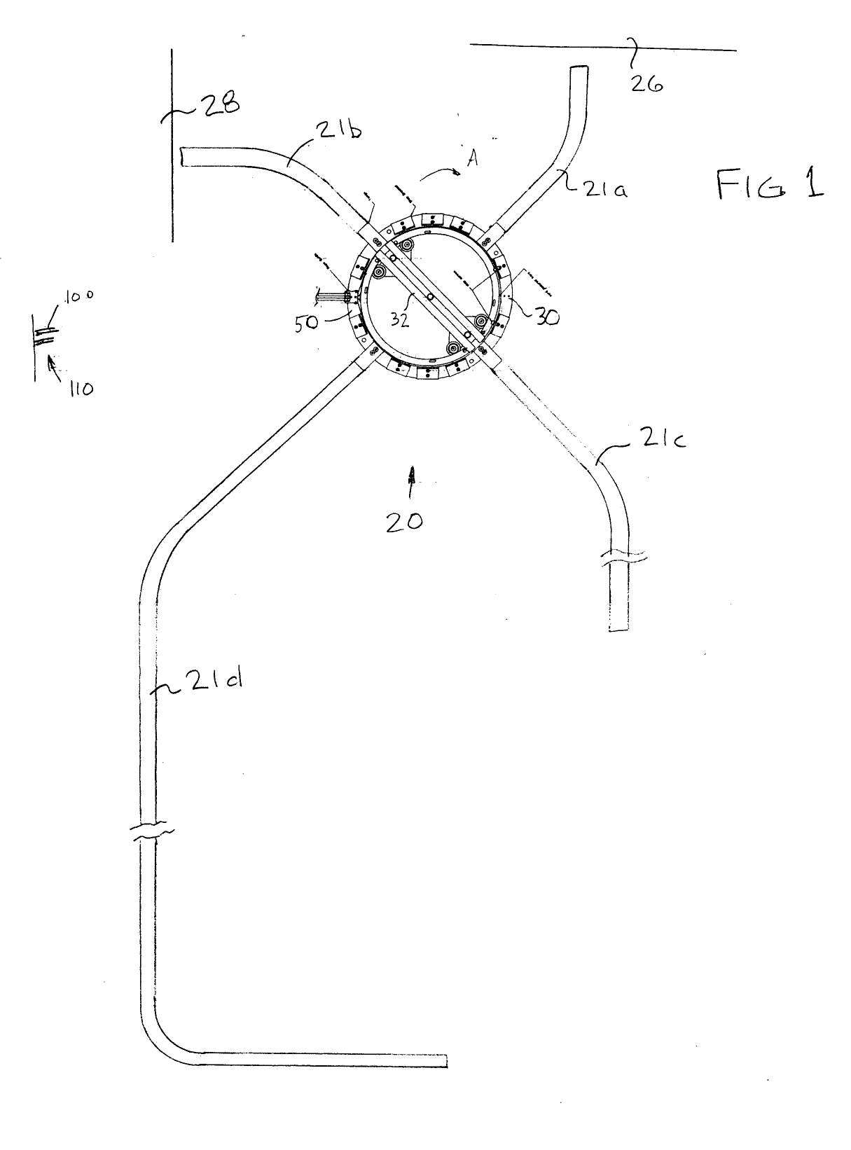

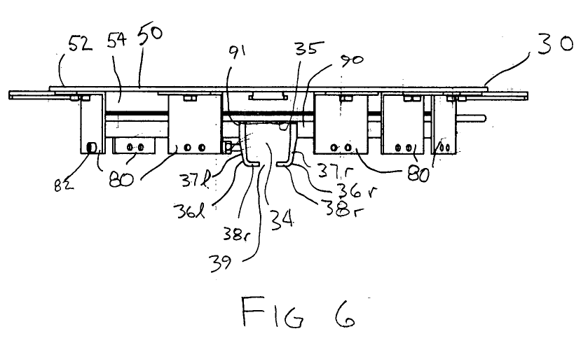

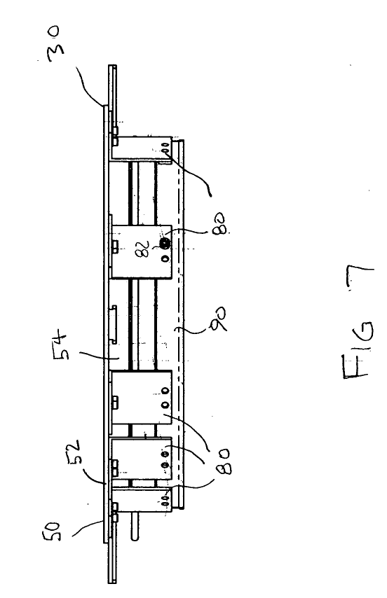

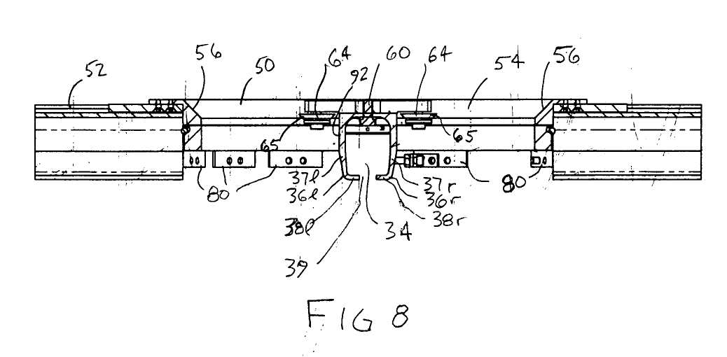

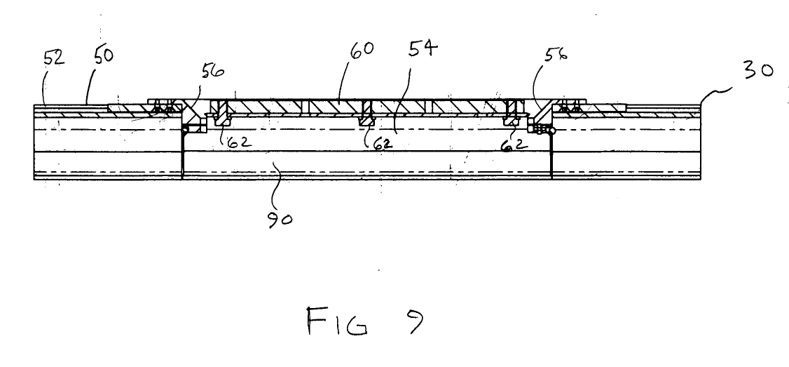

Reference will now be made to FIGS. 1 through 12, which show a preferred embodiment of the patient transfer track system of the present invention, as indicated by general reference numeral 20. The patient transfer track system 20 comprises a plurality of ceiling tracks 22, each ceiling track 21 secured to a ceiling 24 in a building, specifically in a hospital room, as can be best seen in FIG. 1. As illustrated, there are four ceiling tracks, 21a, 21b, 21c, and 21d. The four ceiling tracks, 21a, 21b, 21c, and 21d terminate at a track supported ceiling lift turntable 30, that is also part of the present invention. Ceiling track 21a leads from the ceiling lift turntable 30 to the door 26 of the room. Ceiling track 21b leads from the ceiling lift turntable 30 to the door 28 of the washroom. Ceiling track 21c leads from the ceiling lift turntable 30 to a first bed (not shown). Ceiling track 21d leads from the ceiling lift turntable 30 to a second bed (not shown).

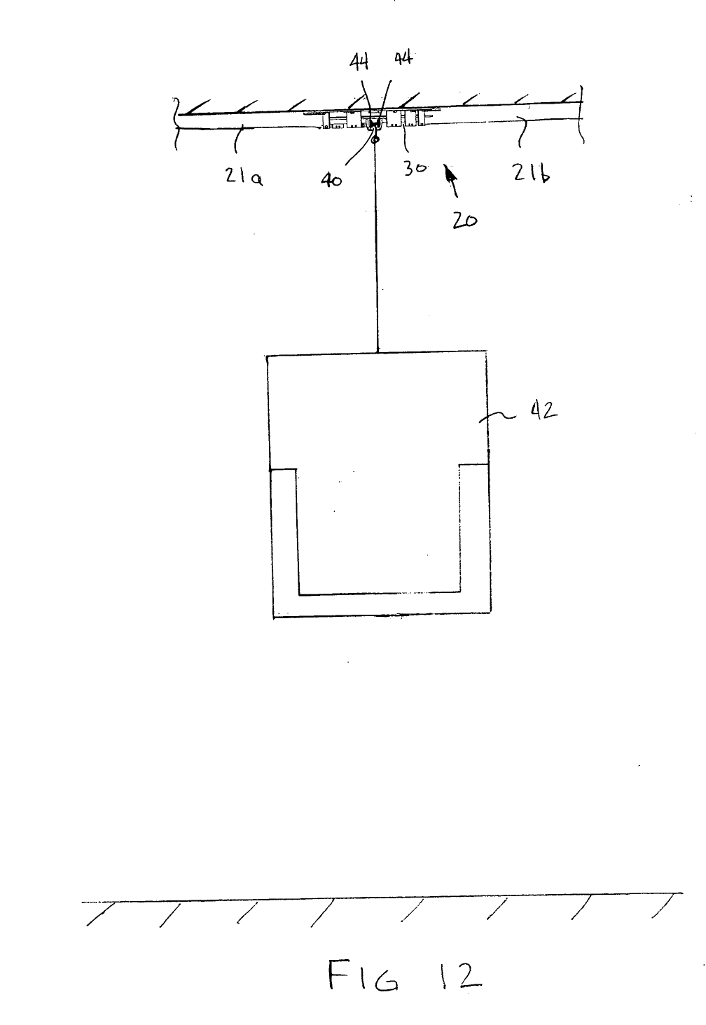

A carriage mechanism 40 having a patient lift mechanism 42 suspended therefrom, as shown in FIG. 12, is movable along the plurality of ceiling tracks, to move a person from one location in the room to another. The carriage mechanism 40 has a plurality of wheels 44 that can engage in rolling relation, the four ceiling tracks, 21a, 21b, 21c, and 21d.

The patient transfer track system 20 also comprises a track supported ceiling lift turntable 30, as discussed above, having a rotatable turntable track member 32 and a plurality of access passageways 34 disposed around the circumference thereof. The access passageways 34 are for permitting the access of the carriage mechanism 40 to the rotatable turntable track member 32 from the ceiling tracks 21a, 21b, 21c, and 21d, and from the rotatable turntable track member 32 to the ceiling tracks 21a, 21b, 21c, and 21d, when the rotatable turntable track member 32 is aligned with the particular access passageway 34.

The track supported ceiling lift turntable 30 also comprises a substantially circular perimeter frame member 50 that has a peripheral top flange 52 and a main cylindrical portion 54 with an interior beveled bearing-receiving surface 56. The rotatable turntable track member 32 is operatively mounted on the perimeter frame member 50 for rotation about a substantially vertical central pivot axis “P”. The rotatable turntable track member 32 comprises an elongate top portion 35 and left and right elongate “L”-shaped rail portions 36l,36r each having a vertical portion 37l,37r and a lower horizontal portion 38l,38r. The left and right elongate “L”-shaped rail portions 36l,36r depend from the elongate top portion 35 in opposed relation one to the other to form a lower slot 39 between the lower horizontal portions 38l,38r. The attachment mechanism 41 of a carriage mechanism 40 is received in the lower slot 39. A spar member 60, commonly called a spyder, is secured in overlying relation to the rotatable turntable track member 32 by a plurality of threaded fasteners 62.

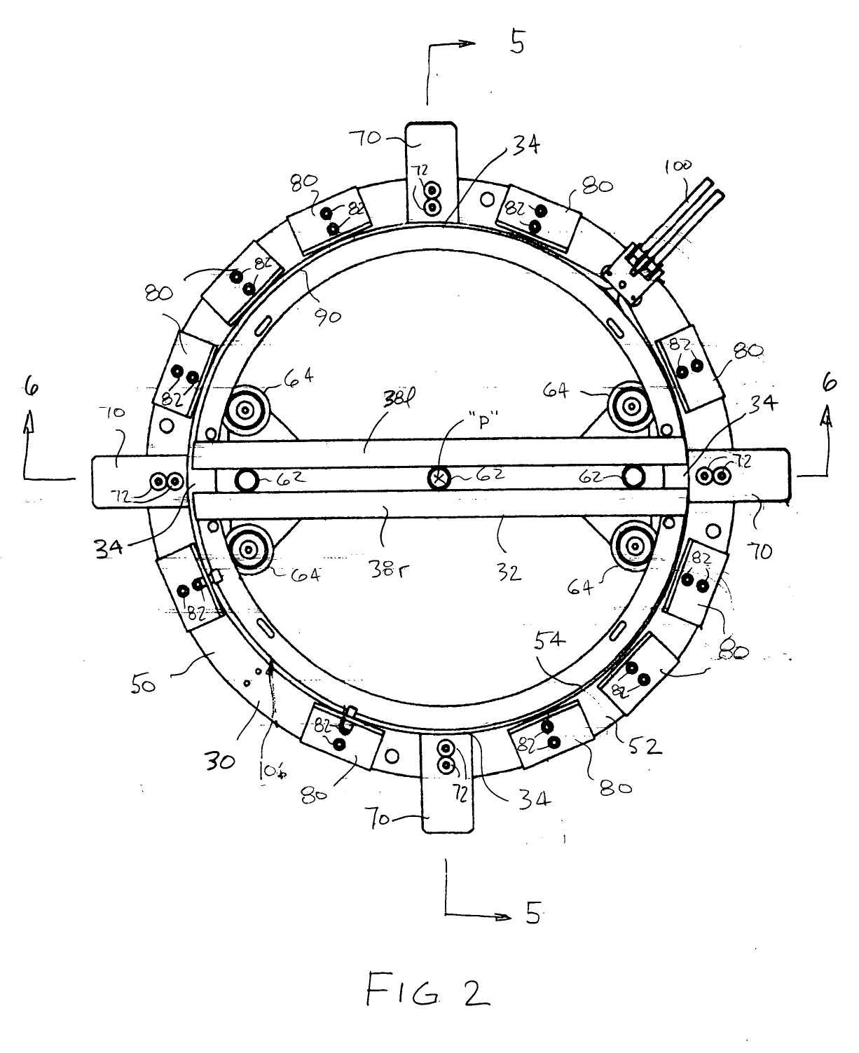

The rotatable turntable track member 32 is operatively mounted on the perimeter frame member 50, for supporting the carriage mechanism 40 and therefore the patient lift mechanism 42 suspended therefrom, in movable relation the rotatable turntable track member 32. As can be best seen in FIGS. 2 through 5, the rotatable turntable track member 32 is operatively mounted on the perimeter frame member 50 by means of a plurality of bearing members 64 operatively mounted in rotatable relation on the spar member of the rotatable turntable track member 32. The plurality of bearing members 64 are mounted in rotatable relation on the spar member. The bearing members 64 each have a beveled upper portion 65 that rotatably engage the co-operating interior beveled bearing-receiving surface 56 of the perimeter frame member 50.

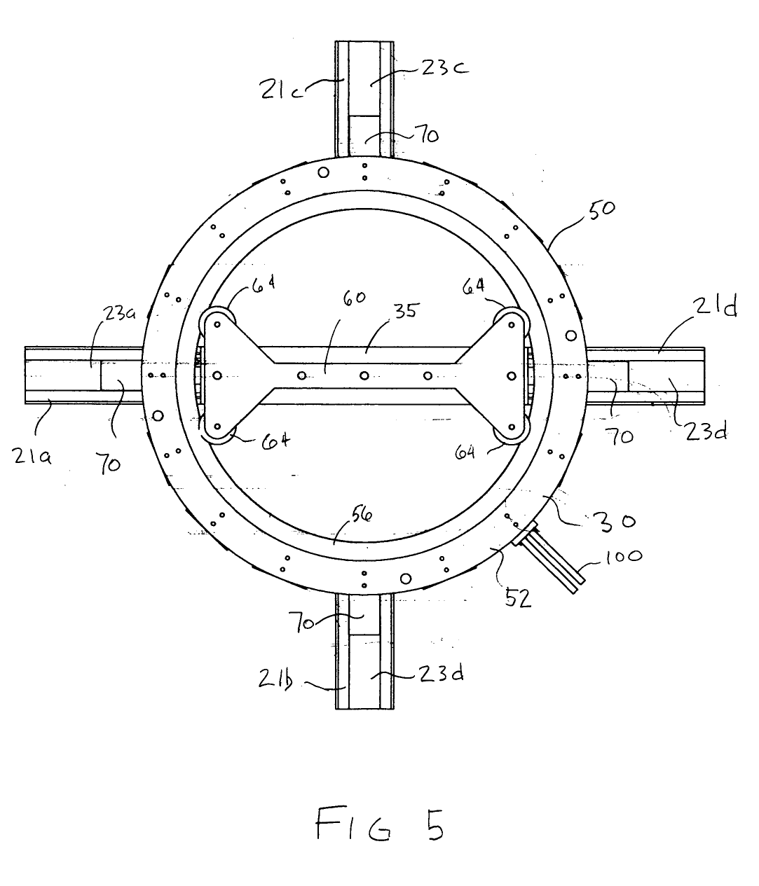

A plurality of tongue members 70 are attached to the peripheral top flange 52 of the substantially circular perimeter frame member 50, and project radially outwardly from around the circumference of the perimeter frame member 50. One tongue member 70 is disposed at each of the plurality of access passageways 34. As can be best seen in FIG. 5, the tongue members 70 engage a mating recess 23a, 23b, 23c, and 23d in one of each of the four ceiling tracks, 21a, 21b, 21c, and 21d that are part of a patient transfer system, so as to connect the four ceiling tracks, 21a, 21b, 21c, and 21d to the track supported ceiling lift turntable 30. In this manner, the ceiling lift turntable 30 is readily mounted to the four ceiling tracks, 21a, 21b, 21c, and 21d.

There is also plurality of stop members 80 mounted in removable and replaceable relation around the circumference of the perimeter frame member 50, specifically on the peripheral top flange 52 of the substantially circular perimeter frame member 50. Each of the stop members 80 blocks one of the plurality of access passageways 34 so as to preclude passage of the carriage mechanism 40 from the rotatable turntable track member 32. In this manner, when the rotatable turntable track member 32 is not aligned with one of the access passageways 34, the carriage mechanism 40 cannot inadvertently roll out of the rotatable turntable track member 32, for safety reasons.

As can be readily seen, the tongue members 70 and the stop members 80 are mounted by means of threaded fasteners 72,82, respectively, engaging co-operating threaded holes 84 in the peripheral top flange 52, at on of a plurality of sixteen places disposed peripherally around the perimeter frame member 50. In essence, the tongue members 70 and the stop members 80 are interchangeable with one another. In this manner, the particular access passageways 34 can be selected to meet with a ceiling track terminating at any one of sixteen angular positions around the perimeter of the track supported ceiling lift turntable 30.

A blocking ring 90 is secured to the rotatable turntable track member 32 for rotation therewith, so as to be adjacent the perimeter frame member 50. The blocking ring 90 comprises first and second openings 91,92 disposed in diametrically opposed relation one to the other. The rotatable turntable track member 32 is received in the first and second openings 91,92. The blocking ring 90 precludes the passage of a carriage mechanism 40 from a ceiling track, when the rotatable turntable track member 32 is not aligned with that particular ceiling track, for safety reasons.

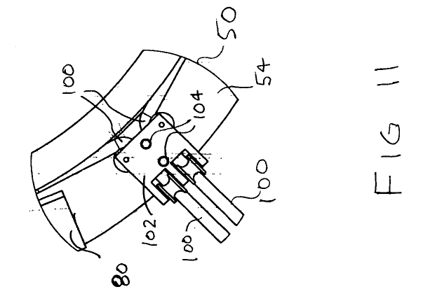

There is also means to rotate the rotatable turntable track member 32 about the vertical central pivot axis to alignment with a selected one of the plurality of access passageways 34, to thereby permit access by a carriage mechanism 40 having a patient lift mechanism 42 suspended therefrom. In the preferred embodiment, as illustrated, the rotatable turntable track member 32 is rotatable about the substantially vertical central pivot axis “P” by means of a rope member 100 secured thereto. More particularly, as can best be seen in FIG. 11, a rope guide 102 is slidably secured to the peripheral top flange 52 of the substantially circular perimeter frame member 50 by means of suitable threaded fasteners 104. The rope member 100 is fed to the rotatable turntable track member 32 by means of the rope guide 102 secured to the perimeter frame member 50. The rope member 100 is secured to the blocking ring 90, that is in turn secured to the rotatable turntable track member 32, by means of a threaded fastener 106 extending through the rope member 100 and threadibly engaging the blocking ring 90. The rope member 100 is preferably made from Polyethylene™ or Nylon™ for strength and durability.

The rope member 100 extends outwardly from the rotatable turntable track member 32 to a remote location 110, as best seen in FIG. 1, such as pulley mounted on a wall. At this remote location 110, the rope is manually manipulable, so as to permit the rotation of the rotatable turntable track member 32 by the rope member 100.

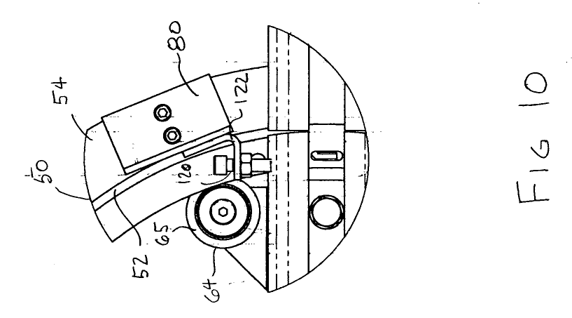

Reference will now be made generally to FIGS. 1 through 4, to discuss the use of the patient transfer track system and track supported ceiling lift turntable 30 of the present invention. As can be seen in FIG. 1, the rotatable turntable track member 32 of the track supported ceiling lift turntable 30 is aligned with the ceiling track 21b and the ceiling track 21c. As can be best seen in FIG. 10, a rubber-tipped stop screw 120 is mounted on one of the stop members 80 by means of a small “J”-shaped bracket 122. The stop screw 120 precludes the rotatable turntable track member 32 from traveling past the rotational position as shown, in one direction. The rotatable turntable track member 32 can, of course, be rotated in the direction, as indicated by arrow “A”. Other means, such as a ball bearing and co-operating detent arrangement could alternatively or additionally be used.

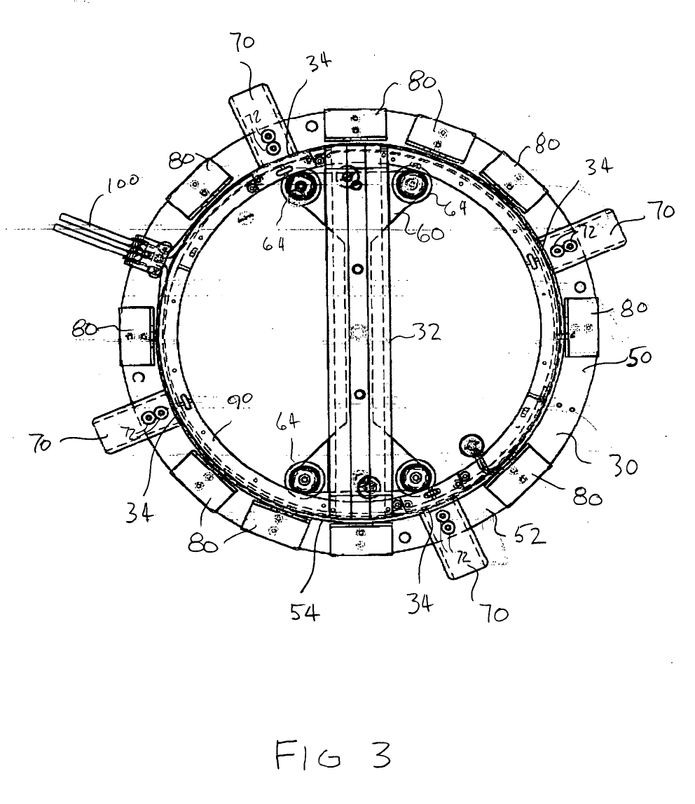

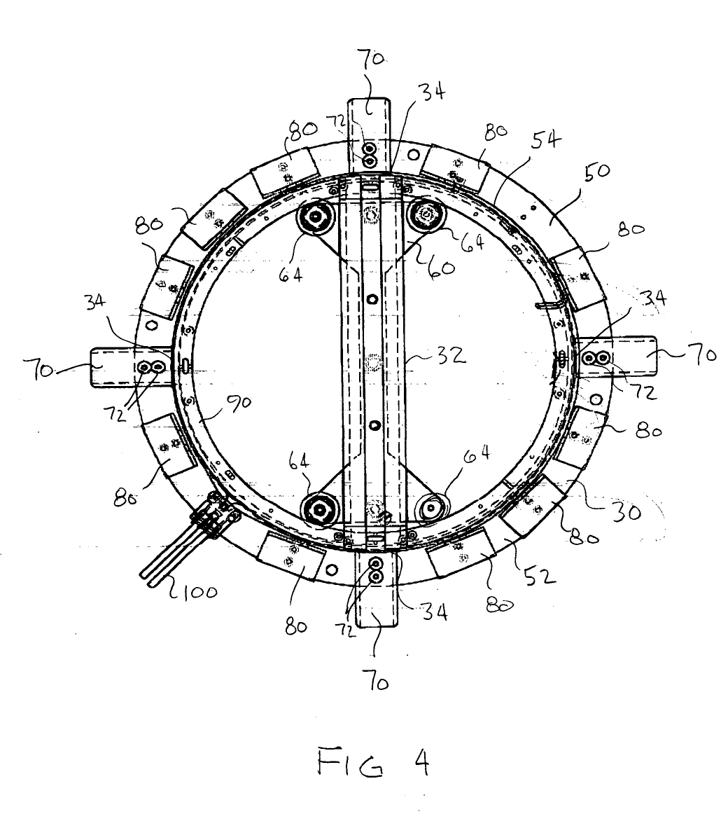

Accordingly, a patient could be moved from the first bed to the washroom and vice versa without rotating the rotatable turntable track member 32. Alternatively, a patient in the first bed could be moved to the ceiling lift turntable 30, and the rotatable turntable track member 32 of the ceiling lift turntable 30 could be rotated by pulling on the rope member 100. The rotatable turntable track member 32 would move past a rotational position as shown in FIG. 3, whereat the two stop members 80 that are aligned with the rotatable turntable track member 32 would preclude the carriage mechanism 40 from rolling off the rotatable turntable track member 32. Upon continued pulling of the rope member 100, the rotatable turntable track member 32 would move to a rotational position as shown in FIG. 4. In this rotational position, the rotatable turntable track member 32 would be aligned with the ceiling track 21a and the ceiling track 21d. Accordingly, a patient could now be moved to the door 26 or to the second bed. The above described example of use is only one example taken from many possible examples.

As can be understood from the above description and from the accompanying drawings, the present invention provides a track supported ceiling lift turntable and patient transfer track system, wherein the track supported ceiling lift turntable is not overly heavy, is not suspended from a load bearing point in the ceiling, is not intensive to install, is inexpensive, and is readily installed, all of which features are unknown in the prior art.

Other variations of the above principles will be apparent to those who are knowledgeable in the field of the invention, and such variations are considered to be within the scope of the present invention. For instance, the rope member used to rotate the rotatable turntable track member could be replaced and the rotatable turntable track member could be driven by an electric motor. Further, other modifications and alterations may be used in the design and manufacture of the track supported ceiling lift turntable and patient transfer track system of the present invention without departing from the spirit and scope of the accompanying claims.

I claim:

1. A track supported ceiling lift turntable for use in a patient transfer track system having a carriage means having a patient lift mechanism suspended therefrom, said track supported ceiling lift turntable comprising:
a perimeter frame member;
a rotatable turntable track member operatively mounted on said perimeter frame member for rotation about a substantially vertical central pivot axis, for supporting a carriage means having a patient lift mechanism suspended therefrom, in movable relation said rotatable turntable track member;
a plurality of access passageways disposed around the circumference of said perimeter frame member, said plurality of access passageways for permitting access of a carriage means to said rotatable turntable track member from ceiling tracks and from said rotatable turntable track member to ceiling tracks; and,
means to rotate said rotatable turntable track member about said vertical central pivot axis to alignment with a selected one of said plurality of access passageways, to thereby permit access by a carriage means having a patient lift mechanism suspended therefrom.

2. The track supported ceiling lift turntable of claim 1, wherein said perimeter frame member is substantially circular.

3. The track supported ceiling lift turntable of claim 1, wherein said rotatable turntable track member comprises an elongate top portion and left and right elongate “L”-shaped rail portions each having a vertical portion and a lower horizontal portion, and depending from said elongate top portion opposed one to the other to form a lower slot between the lower horizontal portions of said left and right elongate “L”-shaped rail portions.

4. The track supported ceiling lift turntable of claim 1, further comprising a plurality of tongue members projecting radially outwardly from around the circumference of said perimeter frame member, one tongue member at each of said plurality of access passageways, wherein said tongue members engage a mating recess on a ceiling track that is part of a patient transfer system.

5. The track supported ceiling lift turntable of claim 1, further comprising a plurality of stop members mounted around the circumference of said perimeter frame member, each of said stop members blocking one of said plurality of access passageways, so as to preclude passage of a carriage means from said rotatable turntable track member.

6. The track supported ceiling lift turntable of claim 5, wherein each of said stop members is mounted in removable and replaceable relation around the circumference of said perimeter frame member.

7. The track supported ceiling lift turntable of claim 1, wherein said rotatable turntable track member is operatively mounted on said perimeter frame member by means of a plurality of bearing members operatively mounted in rotatable relation on said rotatable turntable track member and rotatably engaging a co-operating interior bevelled bearing-receiving surface of said perimeter frame member.

8. The track supported ceiling lift turntable of claim 7, wherein each of said plurality of bearing members has a bevelled upper portion that engages a co-operating bevelled portion on said perimeter frame member.

9. The track supported ceiling lift turntable of claim 8, further comprising a spar member secured in overlying relation to said rotatable turntable track member.

10. The track supported ceiling lift turntable of claim 9, wherein said plurality of bearing members are mounted in rotatable relation on said spar member.

11. The track supported ceiling lift turntable of claim 1, wherein said rotatable turntable track member is rotatable about said substantially vertical central pivot axis by means of a rope member secured thereto and extending outwardly from said rotatable turntable track member to a remote location whereat said rope member is manually manipulable, so as to permit said rotation of said rotatable turntable track member by the rope member.

12. The track supported ceiling lift turntable of claim 1, wherein said rope member is fed to said rotatable turntable track member by means of a rope guide secured to said perimeter frame member.

13. The track supported ceiling lift turntable of claim 1, further comprising a blocking ring secured to said rotatable turntable track member for rotation therewith, so as to be adjacent said perimeter frame member, such that said blocking ring precludes the passage of a carriage means from a ceiling track.

14. The track supported ceiling lift turntable of claim 1, wherein said blocking ring comprises first and second openings disposed in diametrically opposed relation one to the other, and wherein said rotatable turntable track member is received in said first and second openings.

15. A patient transfer track system comprising:
a plurality of ceiling tracks each secured to a ceiling in a building;
a carriage means having a patient lift mechanism suspended therefrom and movable along said plurality of ceiling tracks;
track supported ceiling lift turntable having a rotatable turntable track member and a plurality of access passageways disposed around the circumference thereof, for permitting the access of said carriage means to said rotatable turntable track member from said ceiling tracks and from said rotatable turntable track member to said ceiling tracks; and,
means to rotate said rotatable turntable track member into alignment with a selected one of said plurality of access passageways, to thereby permit access by a carriage means having a patient lift mechanism suspended therefrom.

16. The track supported ceiling lift turntable of claim 15, wherein track supported ceiling lift turntable further comprises a perimeter frame member, and said rotatable turntable track member is rotatably mounted on said perimeter frame member for rotation about a substantially vertical central pivot axis.

17. The track supported ceiling lift turntable of claim 15, wherein said perimeter frame member is substantially circular.

18. The track supported ceiling lift turntable of claim 15, further comprising a plurality of tongue members disposed around the circumference of said perimeter frame member, one tongue member at each of said plurality of access passageways, wherein said tongue members engage a mating recess on a ceiling track that is part of a patient transfer system.

19. The track supported ceiling lift turntable of claim 15, further comprising a plurality of stop members mounted around the circumference of said perimeter frame member, each of said stop members blocking one of said plurality of access passageways, so as to preclude passage of a carriage means.

20. The track supported ceiling lift turntable of claim 15, wherein said rotatable turntable track member is operatively mounted on said perimeter frame member by means of a plurality of bearing members rotatably mounted on said rotatable turntable track member and rotatably engaging a co-operating interior bevelled bearing-receiving surface of said perimeter frame member.
